(19) United States
(12) Patent Application Publication
(10) Pub. No.: US 2013/0105012 A1
(43) Pub. Date: May 2, 2013

(54) DELIVERY DEVICE

(71) Applicant: Carl Stähle, Neunkirch (CH)

(72) Inventor: Carl Stähle, Neunkirch (CH)

(21) Appl. No.: 13/703,672

(22) PCT Filed: Mar. 29, 2011
(86) PCT No.: PCT/EP2011/054849

§ 371 Date: Jan. 7, 2013

(30) Foreign Application Priority Data
Jun. 17, 2010 (EP) 10166260.9

(51) Int. Cl. F17D 1/14

(52) U.S. Cl. CPC F17D 1/14
USPC 137/565.23

(57) ABSTRACT

The delivery device with automatic regulation of the delivery rate comprises a pump device, a suction vessel and a suction sump, wherein the suction vessel has a suction chamber which is connected to the suction sump via an overflow edge and via an inlet duct which opens tangentially into the suction vessel, and wherein the pump device comprises a suction pipe and also a rotary pump which is connected in fluid-conducting fashion to the suction pipe, and wherein the suction pipe projects into the suction vessel from above, and wherein the inlet duct opens into the suction vessel in an alignment corresponding to the direction of rotation of the rotary pump, and wherein the suction pipe is connected to the rotary pump via a connecting pipe, and wherein the connecting pipe has a portion which runs at an angle α of between 45° and 135° with respect to the suction pipe. The portion advantageously runs through a wall. The rotary pump and the suction pipe are particularly advantageously arranged in separate chambers.

The invention relates to a conveying apparatus according to the preamble of claim 1.

### PRIOR ART

The specification CH 580 229 discloses a conveying apparatus for the regulation of the conveyed quantity of centrifugal pumps. This reliable and cost-effective conveying apparatus which has been found to be advantageous per se has the disadvantage that it is more complex to maintain and that it is limited with regard to arrangement possibilities.

### STATEMENT OF INVENTION

An object of the invention is to provide a more advantageous conveying apparatus.

This object is achieved with a conveying apparatus having the features of claim 1. Dependent claims 2 to 15 relate to other advantageous embodiments.

The object is in particular achieved with a conveying apparatus having an automatic regulation of the conveyed quantity, comprising a pump apparatus, a suction container and a suction sump, wherein the suction container has a suction space which is connected to the suction sump via an overflow edge and via an infeed passage opening tangentially into the suction container, and wherein the pump apparatus includes a suction pipe and a centrifugal pump connected to the suction pipe in a fluid-conducting manner, and wherein the suction pipe projects into the suction container from above, and wherein the infeed passage opens into the suction container aligned in accordance with the sense of rotation of the centrifugal pump, and wherein the suction pipe is connected to the centrifugal pump via a connection pipe, and wherein the connection pipe has a part-section which extends at an angle α between 45° and 135° with respect to the suction pipe.

The conveying apparatus comprises a suction space which is constructed as a container, in particular as a cylindrical or prismatic container, the upper edge of the container forming an overflow edge in the direction towards the suction sump. In addition, the container is connected to the suction sump in a fluid-conducting manner by means of a tangential supply line, the supply line preferably extending from the base of the container as far as the overflow edge and the supply line consequently forming an upwardly open passage between the suction sump and the container. As long as the fluid level is above the overflow edge, the container is completely filled with fluid and the conveyed quantity of the pumps is ensured since in this state there is no air or hardly any air in the suction pipe and in the centrifugal pump. If the fluid level falls below the overflow edge, the supply of fluid is carried out exclusively through the infeed passage, to be precise, as a result of the tangential opening, with turbulence production, the turbulence being produced in accordance with the fluid level in the suction sump. The infeed passage is arranged in such a manner that the turbulence produced in the container has the same direction of rotation as the centrifugal pump. This means that the fluid in the suction pipe also has turbulence, which results in the fluid in the suction pipe being able to be conveyed in a reliable manner even when a portion of air or gas is located in the suction pipe or when the quantity of fluid conveyed in the suction pipe is relatively small. The conveying apparatus therefore has automatic regulation, with the pump preferably being able to be operated at a constant speed, the conveyed quantity of fluid adapting automatically and in accordance with the fluid level in the suction sump. It has surprisingly been found that reliable conveying of the fluid between the suction pipe and the centrifugal pump, in particular in the case of low conveyed quantities, is still possible even when a connection pipe is arranged between the suction pipe and the centrifugal pump. The turbulence produced at the inlet of the suction pipe and the turbulence produced by the centrifugal pump result in the turbulence of the fluid also being able to be maintained in the connection pipe in the case of relatively low conveyed quantities. The connection pipe may also have a section which extends at an angle α between 45° and 135° with respect to the suction pipe, in particular at an angle α of 90° or of substantially 90°. In a particularly advantageous manner, the connection pipe has a part-section which extends horizontally or substantially horizontally. In a particularly advantageous embodiment, the suction container and the centrifugal pump are arranged in two spaces separated by a wall, the connection pipe extending through the wall. This arrangement has the advantage that the space in which the suction sump and the suction container are located is separated by a wall from the space in which the centrifugal pump is located. The centrifugal pump can thereby be assembled in a separate and preferably dry space so that the centrifugal pump is preferably readily accessible for maintenance operations. The wall affords additional advantages. For instance, the space in which the centrifugal pump is located can be protected from odour emissions or harmful substances. In addition, it is possible to arrange the base of the space in which the centrifugal pump is located lower than the highest possible level in the suction sump. Owing to the assembly in the dry space, it is also possible, in place of a submersible motor-driven pump, to use a pump which is constructed differently, such as, for example, a bearing block pump.

Consequently, the conveying apparatus according to the invention particularly has the advantage that, in a preferred embodiment, the centrifugal pump can be assembled in a dry space separated from the suction sump so that the centrifugal pump is more accessible and can be better monitored and maintained. In addition, the centrifugal pump can be more easily assembled and also optionally dismantled. In addition, the centrifugal pump is better protected against moisture and aggressive substances. This enables in particular more reliable operation and easier maintenance of the centrifugal pump or the entire conveying apparatus. The conveying apparatus according to the invention further has the advantage that the centrifugal pump can be arranged with a specific spacing with respect to the suction pipe so that more degrees of freedom are possible with respect to the arrangement of the centrifugal pump and suction pipe, whereby more optimal arrangements of the centrifugal pump and suction pipe are possible. The conveying apparatus according to the invention further has the advantage that the suction sump and the suction container can be arranged in an accessible but closed space and that the centrifugal pump can be arranged in a separate, dry space. The closed space in which the suction sump and the suction container are located particularly prevents external emission of odours, whereas the centrifugal pump is readily accessible, and the separate, dry space in which the centrifugal pump is located is preferably odour-free. The conveying apparatus according to the invention consequently has, in an advantageous embodiment, low external emission of odours and preferably has, a separate space for the centrifugal pump, this space being preferably dry and preferably odour-free.

The conveying apparatus according to the invention also has the advantage that the centrifugal pump can be controlled with an on/off switching apparatus. This means that it is sufficient to switch the centrifugal pump on and off in order to operate the entire conveying apparatus or, in other words, no apparatus for speed regulation of the centrifugal pump is required in order to operate the conveying apparatus. This gives rise to the advantage that the control apparatus can be constructed in a very cost-effective and very reliable manner. Conventionally, there is used to control the centrifugal pump a control or regulation apparatus for which at least one desired value is predetermined, at least one actual value or a process value of the conveying apparatus being measured, for example the height of the fluid level in the suction container or the conveyed quantity. The control or regulation apparatus controls the centrifugal pump in a preferred embodiment in such a manner that it is only switched on and off.

### BRIEF DESCRIPTION OF THE DRAWINGS

In the drawings used to explain the exemplary embodiments:

FIG. 1 shows a partially sectioned side view of a conveying apparatus having a centrifugal pump;

FIG. 2 shows a plan view of the conveying apparatus illustrated in FIG. 1;

FIG. 3 shows a side view of another conveying apparatus having a centrifugal pump;

FIGS. 4a, 4b, 4c show schematic side views of pump apparatuses;

FIGS. 5a, 5b, 5c show schematic side views of additional pump apparatuses.

In principle, components which are the same in the drawings are given the same reference numerals.

### METHODS FOR IMPLEMENTING THE INVENTION

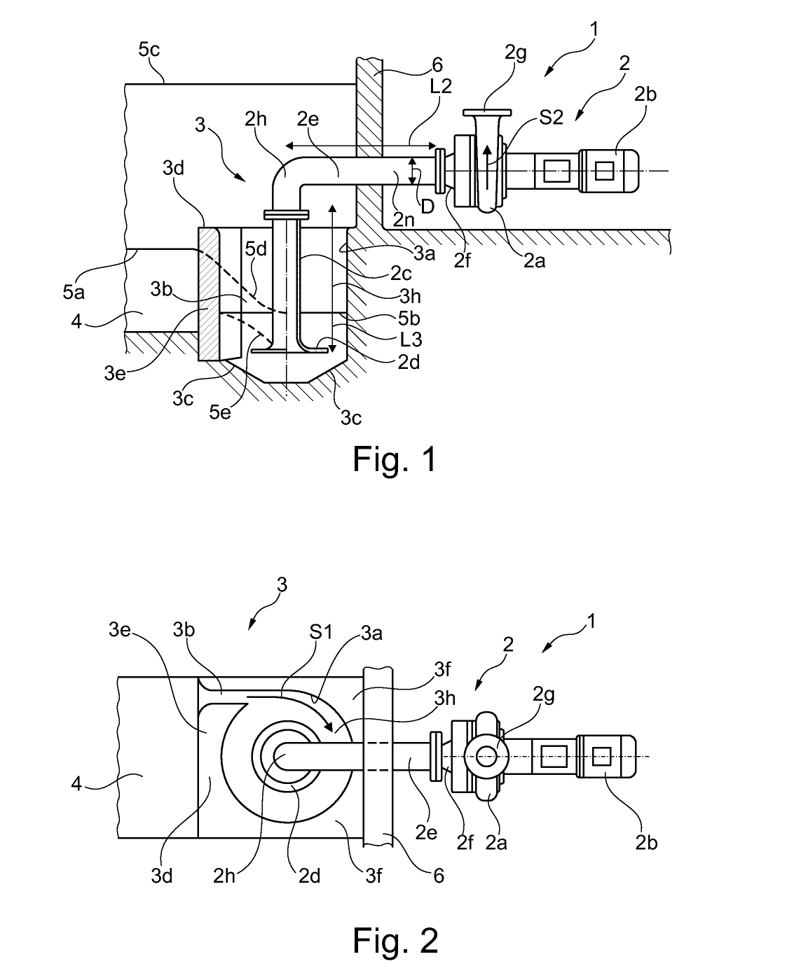

FIG. 1 shows a partially sectioned side view, and FIG. 2 shows a plan view, of a conveying apparatus 1 comprising a pump apparatus 2, a suction container 3 and a suction sump 4. The suction container 3 has side walls 3e, 3f which form a cylindrical side wall 3a and in this manner laterally delimit a suction space 3h. The suction container 3 further comprises a base portion 3c. The suction container 3 further comprises an infeed passage 3b which is arranged laterally and which opens, starting from the suction sump 4, tangentially into the suction space 3h so that the fluid flowing in via the infeed passage 3b brings about turbulence S1 in the suction space 3h. The suction container 3 further has an overflow edge 3d which connects the suction space 3h to the suction sump 4. The pump apparatus 2 comprises a suction pipe 2c, which is connected by means of a connection pipe 2e to a centrifugal pump 2a in a fluid-conducting manner. The suction pipe 2c projects from above into the suction space 3h of the suction container 3, the suction pipe 2c having a suction funnel 2d at the opening thereof. The connection pipe 2e has a pipe elbow 2h of 90° so that the connection pipe 2e extends over a part-section 2n having a length L2 perpendicularly relative to the direction of extent of the suction pipe 2c or in a horizontal manner. The connection pipe 2e opens into a centrifugal pump 2a which is designed as a screw centrifugal wheel pump and which has a suction side 2f, rotation direction S2, drive motor 2b and pump outlet 2g. Between the centrifugal pump 2a and the suction container 3 in the illustrated exemplary embodiment there is arranged a partition wall 6, through which the connection pipe 2e extends. The connection pipe 2e is preferably connected to the partition wall 6 in a fluid-tight manner so that, from the suction container 3, no fluid can reach the space behind the partition wall 6 in which the centrifugal pump 2a is located other than via the connection pipe 2e. In another possible arrangement, it would also be possible to dispense with the partition wall 6. The partition wall 6 could also be constructed from a plurality of part-walls which are arranged beside each other, wherein the part-walls could also be spaced apart from each other, and the intermediate space could be constructed as a hollow space or could be filled with a medium such as an insulation medium. The part-section 2n of the connection pipe 2e preferably extends through the entire partition wall 6.

The connection pipe 2e has an inner diameter D. The inner diameter D is preferably in the range between 50 mm and 900 mm The part-section 2n, along which the connection pipe 2e extends in a linear manner over a length L2, has a length which corresponds to 1 to 50 fold the inner diameter D. The part-section 2n preferably has a length between 0.5 metres and 6 metres. The suction pipe 2c preferably has a suction height which corresponds to 1 to 20 fold the inner diameter D, the suction height having a maximum value of 8 metres. The suction pipe 2c has in particular a suction height L3 between 0.5 metres and 8 metres.

FIG. 1 further shows possible levels of the fluid. The fluid may have a maximum level 5c in the suction sump 4, the fluid conventionally having a lower level, for example, the level 5a, so that the fluid flows via the infeed passage 3b into the suction space 3h so that, for example, the fluid surfaces 5b, 5d and 5e form in the suction space 3h.

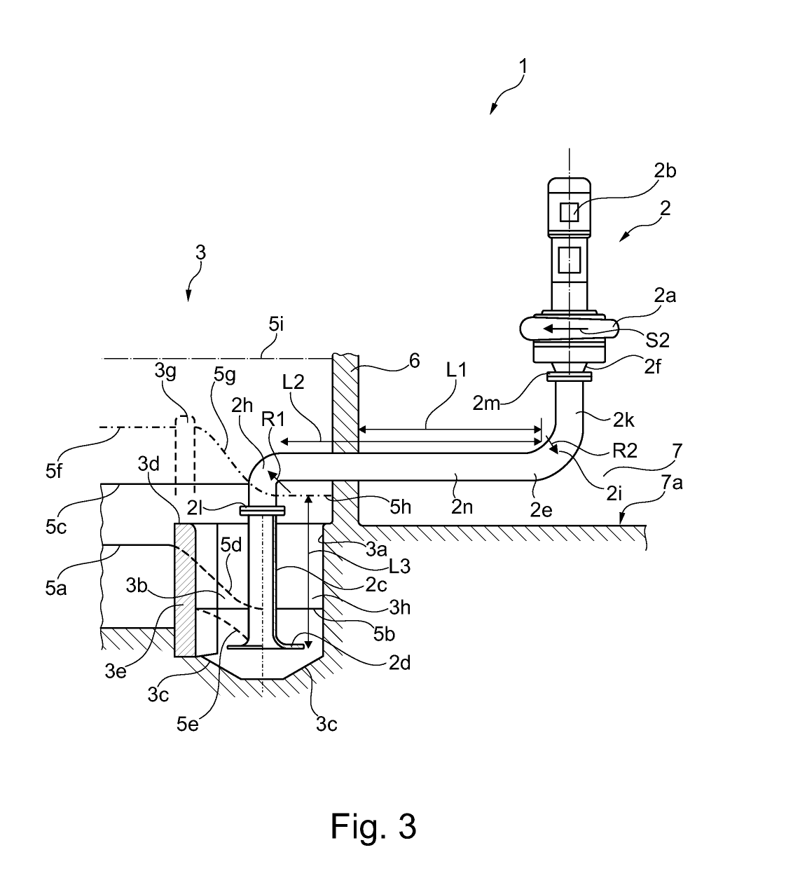

FIG. 3 shows another exemplary embodiment of a conveying apparatus 1. In contrast to the exemplary embodiment according to FIG. 1, the connection pipe 2e in the exemplary embodiment according to FIG. 3 has a second pipe elbow 2i having a vertical pipe section 2k which may adjoin the same, so that the centrifugal pump 2a, as illustrated, is arranged so as to extend in a vertical manner. The radius of curvature R2 of the second pipe elbow 2i may have the same dimensions as the radius of curvature R1 of the first pipe elbow 2h. The centrifugal pump 2a and the drive motor 2b thereof are preferably arranged in a dry space 7. Since the centrifugal pump 2a is arranged behind a wall 6 with respect to the suction container 3, the base 7a of the dry space 7 may also be located lower than the maximum possible level 5i, 5c in the suction sump 4. The overflow edge 3g located between the suction sump 4 and the suction container 3 may, as indicated with broken lines, also be arranged so high that the passage of the connection pipe 2e through the wall 6 is located below the overflow edge 3g. The conveying apparatus 1 according to the invention consequently has inter alia the advantage that the centrifugal pump 2a can be positioned in a large number of possible locations with respect to the suction pipe 2c so that the entire conveying apparatus 1, depending on peripheral structural conditions, can be constructed in a large number of possible manners. Particularly advantageous arrangement possibilities are achieved because the centrifugal pump 2a and the suction pipe 2c can be arranged at different locations. It is further particularly advantageous to arrange the centrifugal pump 2a and the drive motor 2b in a separate space 7.

As long as the entire inner space of the suction pipe 2c and of the connection pipe 2e is filled with fluid, reliable conveying of the fluid through the pump 2a can be ensured. As soon as a relatively small quantity of fluid flows through the suction pipe 2c and the connection pipe 2e, that is to say air is also located in the suction pipe 2c and in the connection pipe 2e, the turbulence of the fluid in the suction pipe and in the connection pipe 2e is of critical importance in order to ensure reliable conveying of the fluid through the pump 2a. The turbulence is maintained, on the one hand, by a turbulence S1 being produced in the inlet region of the suction pipe 2c, that is to say in the suction space 2h, and, on the other hand, by a turbulence S2 being produced by the centrifugal pump 2a, this turbulence acting, from the centrifugal pump 2a, on the fluid located in the connection pipe 2e. Consequently, the turbulence of the fluid in the connection pipe 2e at both end regions thereof is excited by the turbulence S1 or S2, which results in the fluid in the connection pipe 2e, even in the case of relatively low fluid quantities, having such turbulence that the fluid column does not break off and consequently continuous pumping of the fluid by means of the centrifugal pump 2 is possible.

In FIG. 3, the connection pipe 2e is constructed in one piece and has a flange 2l, 2m at each of the two ends, these flanges being respectively connected to the suction pipe 2c and the centrifugal pump 2a. The connection pipe 2e may naturally also comprise a plurality of components, with, for example, the pipe elbows 2h, 2i being constructed as separate components which can be securely connected to the part-section 2n in order to form the connection pipe 2e in the assembled state.

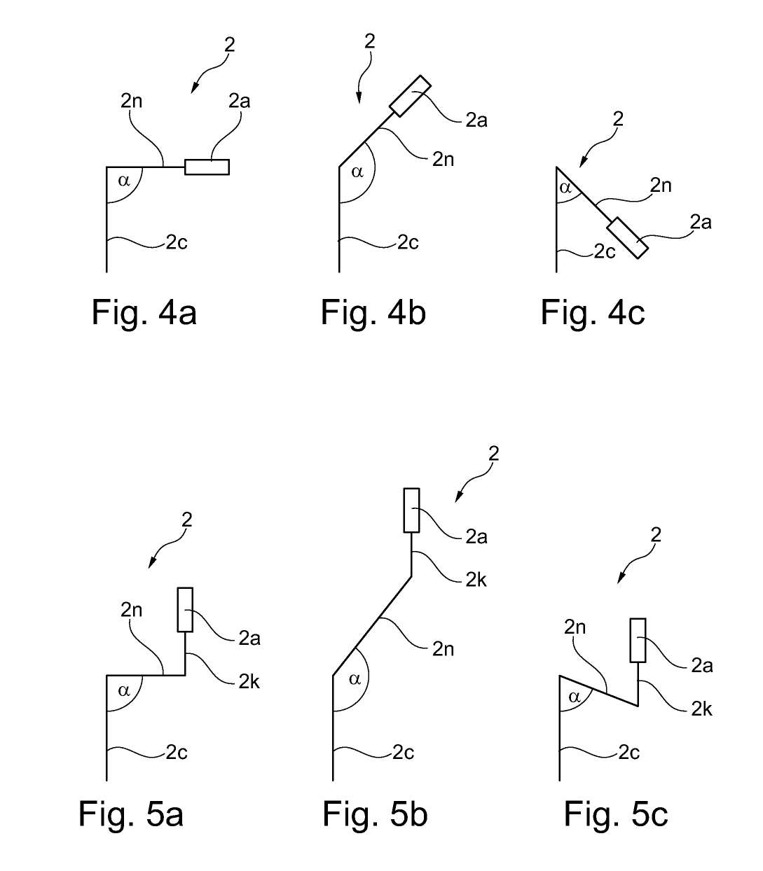

FIGS. 4a to 4c and 5a to 5c schematically show arrangement possibilities of the suction pipe 2c, connection pipe 2e and part-section 2n and centrifugal pump 2a. In FIG. 4a, the angle α between the suction pipe 2c and the part-section 2n of the connection pipe 2e is 90° so that the suction pipe 2c preferably extends in a vertical manner and the part-section 2n of the connection pipe 2e preferably extends in a horizontal manner. However, the angle α, as illustrated in FIGS. 4b and 4c, may be selected to be larger or smaller so that the part-section 2n of the connection pipe 2e extends at an angle α between 45° and 135° with respect to the suction pipe 2c. Even in the case of a vertically arranged centrifugal pump 2a, the part-section 2n of the connection pipe 2e may, as illustrated in FIGS. 5a to 5c, have an angle α in the range from 45° to 135° between the extent of the suction pipe 2c and the part-section 2n of the connection pipe 2e, so that the centrifugal pump 2a can be arranged in a large number of possible manners with respect to the suction pipe 2c.

1. A conveying apparatus having an automatic regulation of the conveyed quantity, comprising
a pump apparatus, a suction container and a suction sump,
wherein the suction container has a suction space which is connected to the suction sump via an overflow edge and via an infeed passage opening tangentially into the suction container,
wherein the pump apparatus includes a suction pipe and a centrifugal pump connected to the suction pipe in a fluid-conducting manner,
wherein the suction pipe projects into the suction container from above,
wherein the infeed passage opens into the suction container aligned in accordance with the sense of rotation of the centrifugal pump,
wherein the suction pipe is connected to the centrifugal pump via a connection pipe; and
wherein the connection pipe has a part section which extends at an angle α between 45° and 135° with respect to the suction pipe.

2. A conveying apparatus in accordance with claim 1, wherein the part section extends at an angle α of 90° or of substantially 90°.

3. A conveying apparatus in accordance with claim 1, wherein the part section extends horizontally.

4. A conveying apparatus in accordance with claim 1, wherein the connection pipe has an inner diameter between 50 mm and 900 mm.

5. A conveying apparatus in accordance with claim 4, wherein the part section has a length which correspond to 1 to 50 times the inner diameter.

6. A conveying apparatus in accordance with claim 4, wherein the part section has a length between 0.5 meters and 6 meters.

7. A conveying apparatus in accordance with claim 4, wherein the suction pipe has a suction height which corresponds to 1 to 20 times the inner diameter.

8. A conveying apparatus in accordance with claim 4, wherein the suction pipe has a suction height between 0.5 meters and 8 meters.

9. A conveying apparatus in accordance with claim 4, wherein the connection pipe has a pipe elbow toward the suction pipe; and wherein the pipe elbow has a radius which corresponds to 1 to 10 times the inner diameter.

10. A conveying apparatus in accordance with claim 1, wherein the centrifugal pump is connected in a horizontally extending manner to the connection pipe.

11. A conveying apparatus in accordance with claim 1, wherein the connection pipe has a pipe elbow toward the centrifugal pump; and wherein the centrifugal pump is connected in a vertically or substantially vertically extending manner to the connection pipe.

12. A conveying apparatus in accordance with claim 1, wherein the suction container and the centrifugal pump are arranged in two spaces separated by a wall; and wherein the connection pipe extends through the wall.

13. A conveying apparatus in accordance with claim 12, wherein the centrifugal pump is arranged in a space whose base lies lower than the highest possible level in the suction container.

14. A conveying apparatus in accordance with claim 1, wherein the centrifugal pump can be controlled via an on/off switching apparatus.

15. A conveying apparatus in accordance with claim 1, wherein the centrifugal pump is designed as a screw centrifugal wheel pump.
